(19) United States
(12) Patent Application Publication
(10) Pub. No.: US 2017/0131796 A1
(43) Pub. Date: May 11, 2017

(54) CALIBRATING METHODOLOGY OF STYLUS PRESSURE MAPPING CURVE FOR MATCHING MICROSOFT® WINDOW 10 STANDARD IN MASS PRODUCTION

(71) Applicant: WALTOP INTERNATIONAL CORPORATION, Hsinchu City (TW)

(72) Inventors: A-Li Wong, Hsinchu City (TW); Chih-Hung Huang, Hsinchu City (TW)

(21) Appl. No.: 14/934,075

(22) Filed: Nov. 5, 2015

(51) Int. Cl. G06F 3/038; G06F 3/0354

(52) U.S. Cl. CPC G06F 3/0383; G06F 3/03545

(57) ABSTRACT

The invention provides a method for calibrating stylus pressure mapping curve. First of all, data of average pressure sensing signal values are generated. Then data of standard pressure levels are generated. Next a standard pressure level mapping curve of average pressure sensing signal values via standard pressure levels is generated. Then a pressure sensing signal value of a stylus under calibration is generated. Next the calibrated pressure sensing signal value is compared with the average pressure sensing signal value to generate a calibration reference value, wherein the calibrated pressure sensing signal value and the average pressure sensing signal are corresponding to the same weight applied on the stylus. Finally, data of pressure sensing signal values of the stylus is calibrated by the calibration reference value, thereby mapped to the pressure levels matching the standard pressure curve via the standard pressure level mapping curve.

### BACKGROUND OF RELATED ART

1. Technical Field

The present invention generally relates to a method for calibrating stylus pressure mapping curve, and more particularly to a method for calibrating stylus pressure mapping curve for matching Microsoft® Window 10 standard in mass production.

2. Description of Related Art

Capacitive touch input technology is the mainstream of the input technologies applied to the widely used touch panel. A typical capacitive touch panel includes substrates on which transparent electrode patterns are coated thereon. When a finger or a stylus touch or hover on the touch panel, coupling capacitance is formed between the finger or the stylus and the transparent electrode patterns because the finger or the tip of the stylus is a conductive to establish capacitive coupling with the transparent electrode patterns. Meanwhile, the capacitance of the electrode pattern under the finger or the stylus on the touch panel will change, thus the voltage or the current in the electrodes of the electrode patterns will change. By comparing a voltage difference between the electrode under the finger or the stylus and the adjacent electrodes, the coordinate of the finger or the stylus can be determined.

However, the fingers of user are not suitable for a more delicate writing input operation, such as the writing input operations with stroke thickness changes. Moreover, input operation by using user's fingers also lacks various functions. Thus a stylus instead of user's fingers is used to perform exquisite input operation upon a touch panel with a capacitive touch input function. The stylus can further allow user to depict lines with various stroke thicknesses on a touch panel. The stylus can also detect the force which a user applies upon the stylus against the touch panel.

The stroke thickness of a stylus displayed on the touch panel is a result of signals generated from a pressure sensing module of the stylus. The stroke thickness of a stylus displayed on a touch panel should be proportional to the pressure applied on the tip of the stylus in an ideal condition. However, due to various issues, such as physical and mechanical errors of pressure detection components of the stylus or non-uniform characteristics of a pressure sensor of the stylus, the signals generated from the pressure sensing module of the stylus do not always match the pressure applied on the tip of the stylus. Thus since styluses usually have different physical and mechanical errors of pressure detection components and slightly different characteristics of pressure sensors, the styluses may have various tip pressure sensitivities. Obviously, the styluses will need to be calibrated before leaving the factory. Thus the invention provides a method for calibrating stylus pressure mapping curve for matching Microsoft® Window 10 standard in mass production.

### SUMMARY

The invention provides a method for calibrating stylus pressure mapping curve. First of all, data of average pressure sensing signal values are generated. Then data of standard pressure levels are generated. Next a standard pressure level mapping curve of average pressure sensing signal values via standard pressure levels is generated. Then a pressure sensing signal value of a stylus under calibration is generated. Next the calibrated pressure sensing signal value is compared with the average pressure sensing signal value to generate a calibration reference value, wherein the calibrated pressure sensing signal value and the average pressure sensing signal are corresponding to the same weight applied on the stylus. Finally, data of pressure sensing signal values of the stylus is calibrated by the calibration reference value, thereby mapped to the pressure levels matching the standard pressure curve via the standard pressure level mapping curve.

The invention further provides a stylus with pressure mapping function. The stylus comprises a control unit with embedded non-transitory computer readable medium storing executable instructions for performing a method for calibrating stylus pressure mapping curve. The method comprises generating data of average pressure sensing signal values; generating data of standard pressure levels; generating a standard pressure level mapping curve of average pressure sensing signal values via standard pressure levels; generating a pressure sensing signal value of the stylus under calibration; comparing the calibrated pressure sensing signal value with the average pressure sensing signal value to generate a calibration reference value, wherein the calibrated pressure sensing signal value and the average pressure sensing signal value are corresponding to the same weight applied on the stylus; and calibrating data of pressure sensing signal values of the stylus by the calibration reference value, thereby mapping to the pressure levels matching the standard pressure curve via the standard pressure level mapping curve.

### BRIEF DESCRIPTION OF THE DRAWINGS

FIG. 1 shows a schematic diagram of a stylus 100 on a touch panel 10 according one embodiment of the invention.

FIG. 2 shows a schematic diagram illustrating diversified pressure sensing signal curves of styluses.

FIG. 3 shows a schematic diagram illustrating shifted pressure sensing signal curves of a plurality of styluses.

FIG. 4 shows a schematic diagram illustrating a reference sensing signal curve of a plurality of styluses according to one embodiment of the invention.

FIG. 5 shows a schematic diagram illustrating a standard pressure level curve according to one embodiment of the invention.

FIG. 6 shows a schematic diagram illustrating a standard pressure level mapping curve according to one embodiment of the invention.

FIG. 7 shows a schematic diagram illustrating calibrated mapping of diversified pressure sensing signal curves of styluses according to one embodiment of the invention.

FIG. 8 shows a schematic diagram illustrating mapping of pressure level curves of styluses according to one embodiment of the invention.

FIGS. 9 and 10 show schematic diagrams illustrating how a stylus is calibrated on a touch panel according to one embodiment of the invention.

FIG. 11 depicts a method for adjusting stylus pressure mapping curve according to one embodiment of the invention.

### DETAILED DESCRIPTION

Embodiment of this invention will be described in detail below. However, in addition to as described below, and this invention can be broadly implemented in the other cases the purpose and scope of this invention is not affected by the application of qualified, claim after its prevail. Furthermore, to provide a description more clear and easier to understand the invention, the pieces within the schema and not in accordance with their relative size of drawing, compared to certain dimensions to other scales have been exaggerated; details not related nor completely drawn in part in order to schematic simplicity.

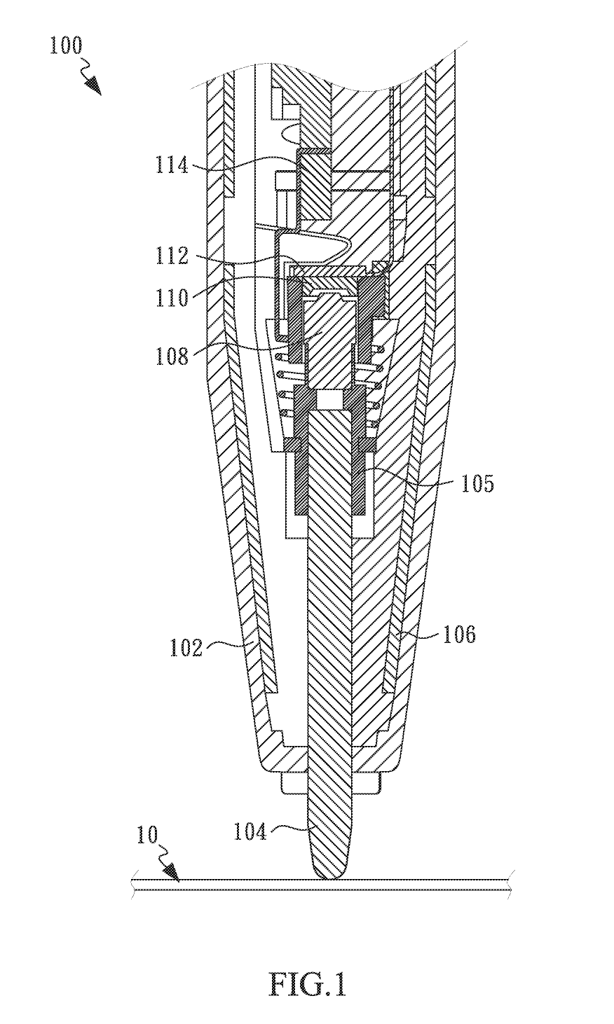

FIG. 1 shows a schematic diagram of a stylus 100 on a touch panel 10 according one embodiment of the invention. FIG. 1 shows a schematic diagram of a stylus 100 touching a touch panel 10 according one embodiment of the invention. The stylus 100 is utilized to perform exquisite input operation upon the touch panel 10. In this embodiment, the stylus 100 comprises a housing 102, a conductive nib 104, a nib holder 105, a shielding 106, an elastomer 108, a pressure sensor 110, a pressure sensor circuit board 112 and a control circuit board 114. The conductive nib 104 is configured to electrically couple to the control circuit board 114 and to establish capacitive coupling with transparent electrodes on the touch panel 10. The capacitances of the transparent electrodes on the touch panel 10 under the conductive nib 104 will change and voltages or currents in the electrodes will also change. The coordinates of the stylus 100 can thus be detected through changes of capacitances, voltages or currents in the electrodes.

In this embodiment, the conductive nib 104, the nib holder 105, the elastomer 108, the pressure sensor 110 and the pressure sensor circuit board 112 are configured to provide the stylus 100 with tip pressure detection. Some components can be further included to enhance the performance, such as a spring to restore the conductive nib 104 back to the original position after tip pressure is removed. In other embodiments, various pressure sensing modules can be used to provide the stylus 100 with tip pressure detection.

The stylus further comprises a control unit (not shown) on the control circuit board 114. The control unit comprises a microprocessor unit or MCU with embedded non-volatile memory or non-transitory computer readable medium such as flash memory. The control unit calculates the tip pressure applied on the stylus 100 via signals from the pressure sensor 110. The signals from the pressure sensor 110 may fluctuate due to various reasons. For example, physical and mechanical errors or size inaccuracy of the conductive nib 104, the nib holder 105, the elastomer 108 or the spring to restore the conductive nib 104 resulting from manufacture issues or assembling causes, and the fluctuated contact condition between the elastomer 108 and the pressure sensor 110 amid the use of the stylus 100. The control unit outputs pressure sensing signals via the conductive nib 104 to the touch panel 10. The touch panel 10 displays strokes of the stylus 100 according to coordinates of the stylus 100 and stroke thicknesses according to pressure sensing signals. The pressure sensing signals may be converted to a digital value by an ADC (Analog Digital Converter) in the touch panel 10. Ideally, the pressure sensing signals should be proportional to the tip pressure applied on the tip of the conductive nib 104. However, the physical and mechanical errors of pressure sensing modules of different styluses may cause diversified pressure sensitivities. The relation between the pressure sensing signals and the tip pressure applied on the tip of the conductive nib 104 forms a pressure sensing signal curve of the stylus 100.

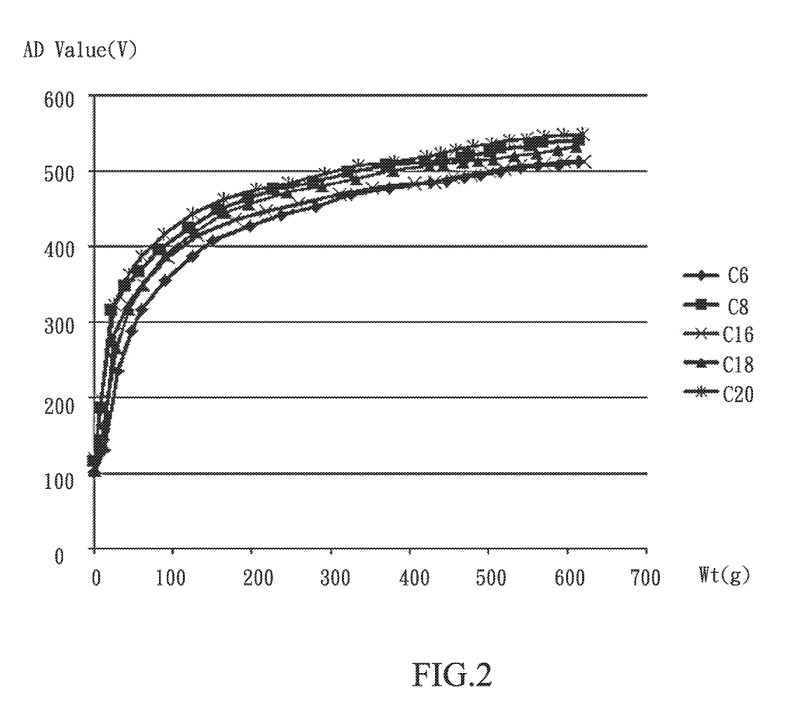

FIG. 2 shows a schematic diagram illustrating pressure sensing signal curves of a plurality of styluses. In this diagram, five styluses C6. C8, C16, C18 and C20 are applied with weights by using a tool on a touch panel to generate pressure sensing signal curves. Details of how these curves are generated will be further described in the following content. These pressure sensing signal curves are depicted by raw data of pressure sensing signal values from the styluses via applying a plurality of weights with different weight values on a tool and the styluses. These pressure sensing signal curves show diversified pressure sensitivities of the styluses possibly due to the physical and mechanical errors of pressure sensing modules of styluses.

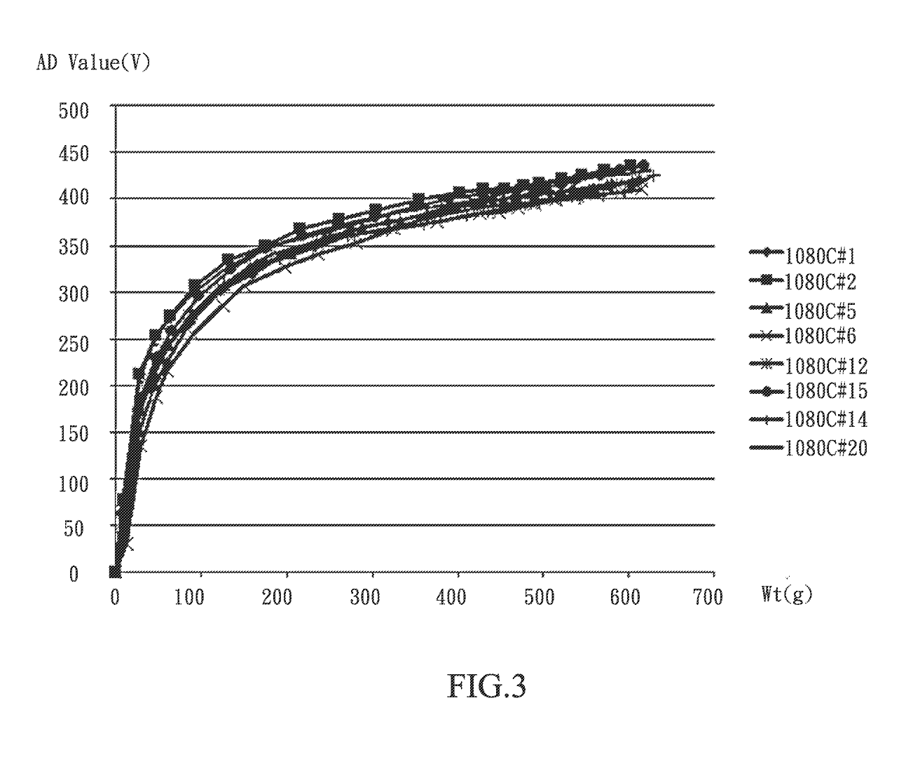

FIG. 3 shows a schematic diagram illustrating shifted pressure sensing signal curves of a plurality of styluses. In this diagram, styluses C1, C2, C5, C6. C12, C14, C15 and C20 are applied with weights by using a tool on a touch panel to generate pressure sensing signal curves. These pressure sensing signal curves are depicted by raw data of sensing signal values from the styluses via applying weights on a tool and the styluses. These raw data of pressure sensing signal values are further calculated by the following equation to form shifted pressure sensing signal curves of the styluses.

Vₛ(x)=V(x)−V(0)

Vₛ is a shifted pressure sensing signal value and x is a weight applied on the styluses, while V is a pressure sensing signal value from the styluses and V(0) is the pressure sensing signal value without adding any weight on the styluses. The pressure sensing signal curves can be easily obtained by using a spreadsheet or an interactive computer application program.

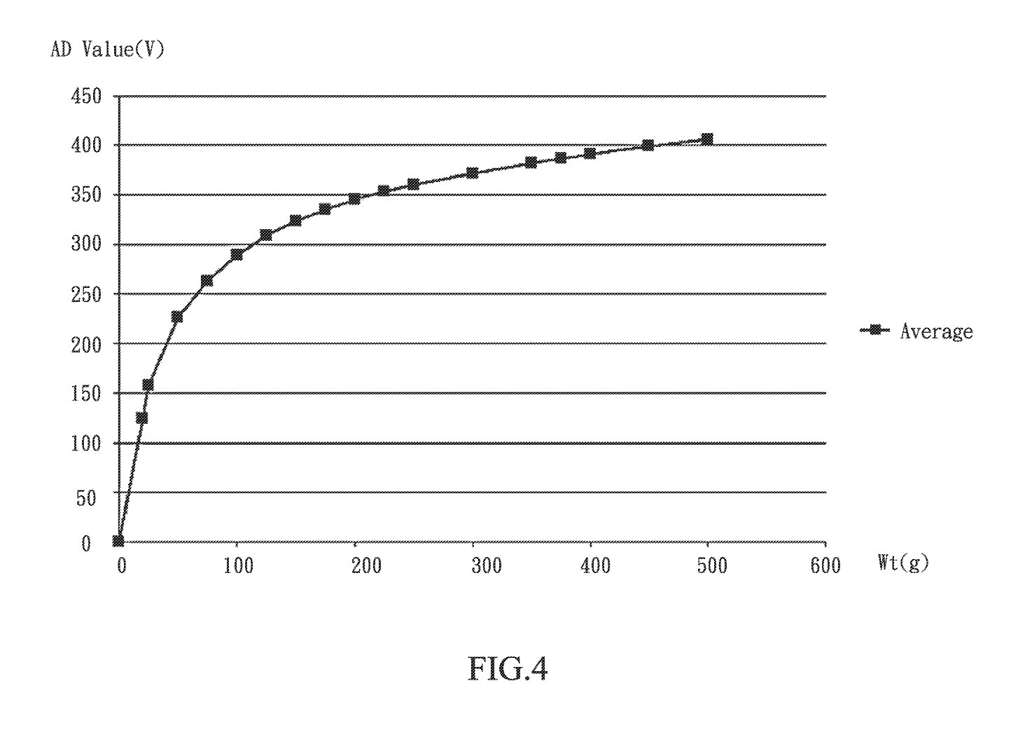

FIG. 4 shows a schematic diagram illustrating a reference sensing signal curve of a plurality of styluses according to one embodiment of the invention. In this diagram, average pressure sensing signal values of a plurality of styluses are calculated by the following equation.

Vₐ(x)=SUM(V₁(x)+ . . . +Vₙ(x))/n

Vₐ is an average pressure sensing signal value, while V₁(x) and Vₙ(x) represent pressure sensing signal values of stylus 1 and stylus n with weight x applied thereon. For example, the data of the shifted pressure sensing signal values shown in FIG. 3 are summed and then divided by the number of the styluses to obtain the average pressure sensing signal values. The data of average pressure sensing signal curve can be encoded in the embedded non-volatile memory of the control unit of every stylus as a reference sensing signal curve for calibrating styluses during production.

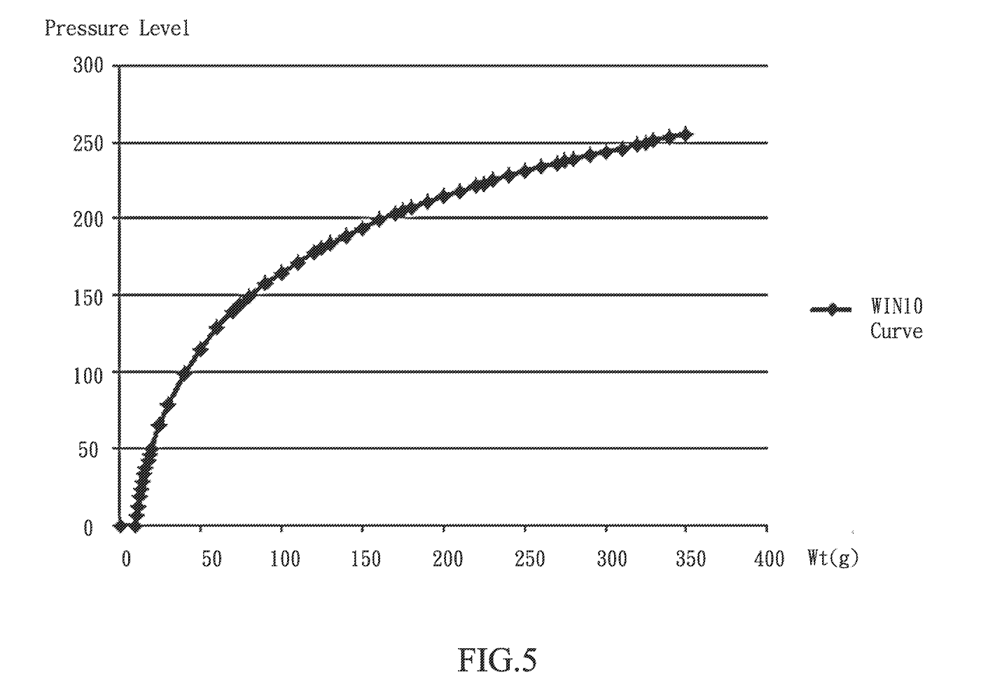

FIG. 5 shows a schematic diagram illustrating a standard pressure level curve according to one embodiment of the invention. In this diagram, a standard pressure level curve is generated to meet the requirement of Microsoft® Window 10 standard for stylus. The pressure level can be calculated by the following equation.

P(x)=LN(x)*71.723−165.15

P(x) is pressure level of a stylus with weight x applied thereon LN(x) is the Natural Logarithmic function. The value of pressure level is from 0 to 255 and thus there are 256 levels. The pressure levels are corresponding to stroke thicknesses displayed on a touch panel.

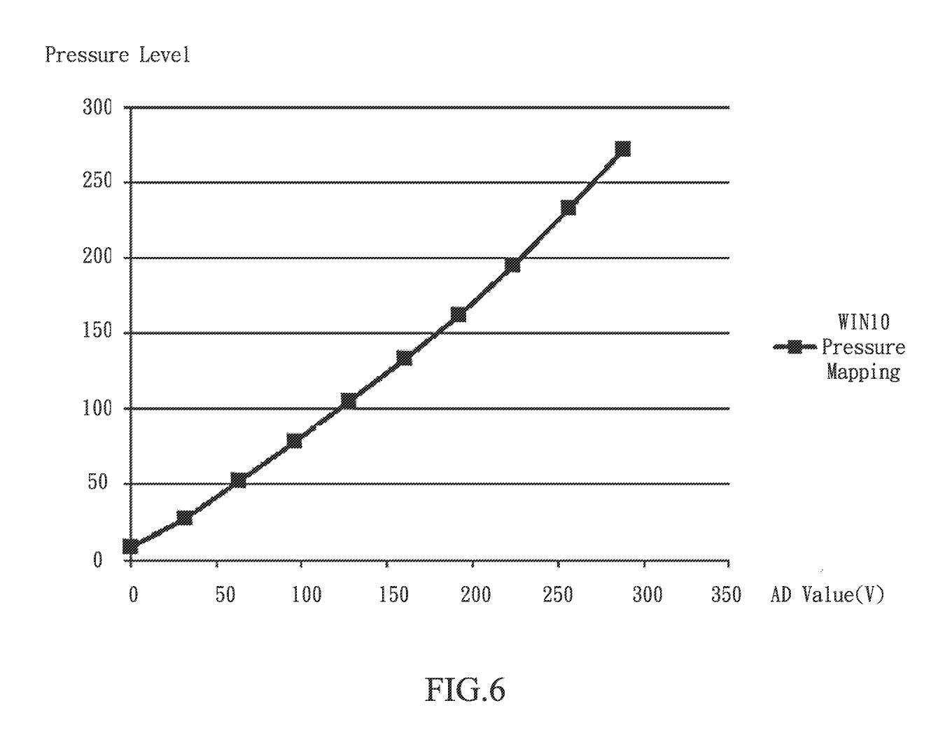

FIG. 6 shows a schematic diagram illustrating a standard pressure level mapping curve according to one embodiment of the invention. This pressure level mapping curve is generated from the data of the average pressure sensing signal values of the reference pressure level mapping curve shown in FIG. 4 and the data of the standard pressure level curve shown in FIG. 5. The data of this pressure level mapping curve are encoded in the embedded non-volatile memory of the control unit of every stylus produced as a standard pressure level mapping curve for calibrating styluses during production. The standard pressure level mapping curve can be obtained by using a spreadsheet or an interactive computer application program.

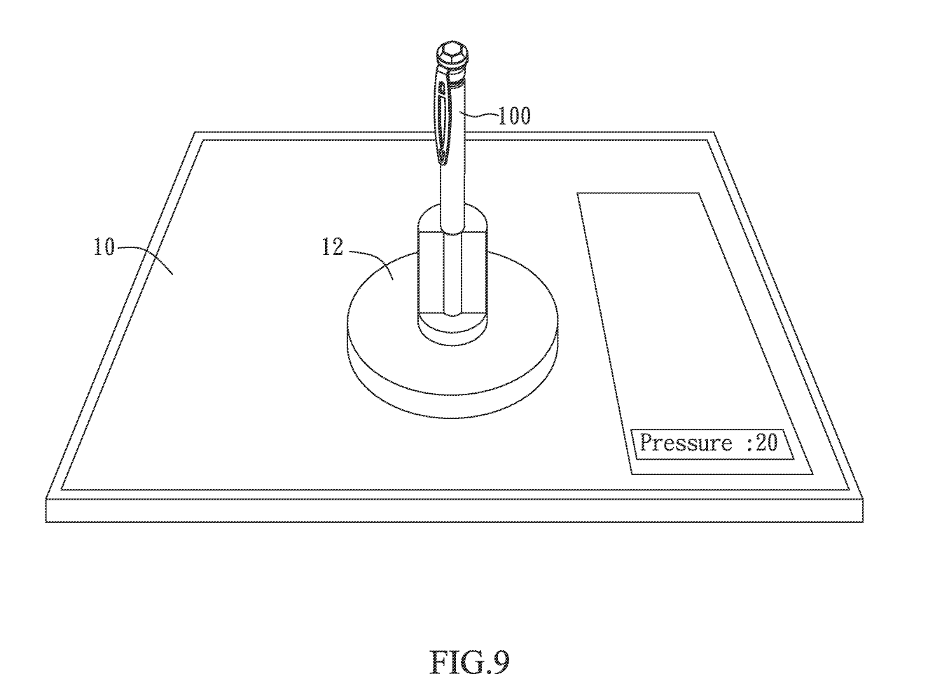

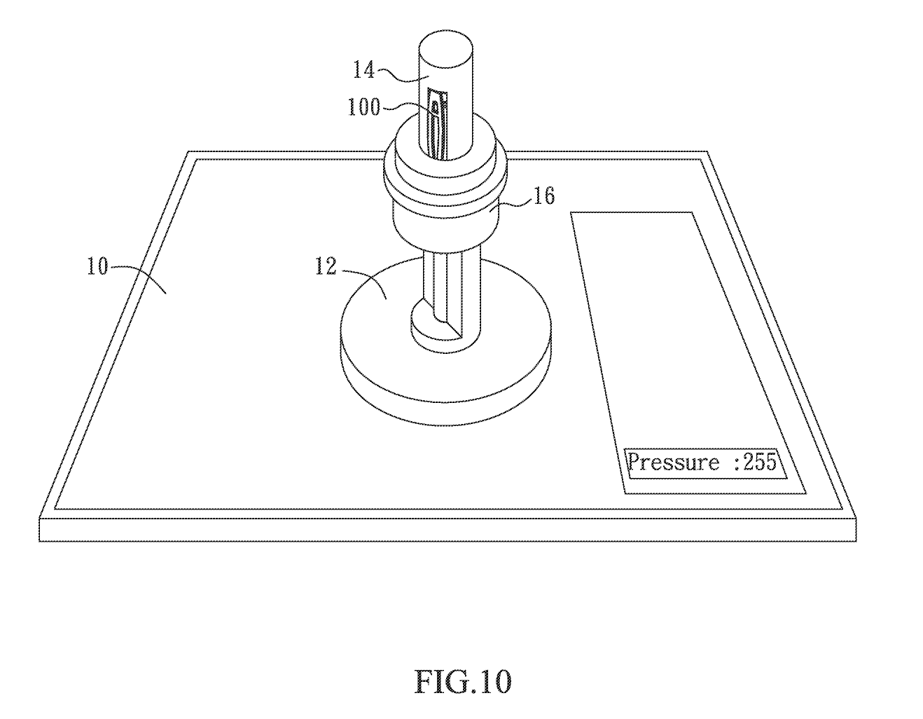

FIGS. 9 and 10 show schematic diagrams illustrating how a stylus is calibrated on a touch panel according to one embodiment of the invention. As shown in FIG. 9, the stylus 100 is vertically held on a tool 12 upon the touch panel 10. As shown in FIG. 10, a weight 16 is further applied upon the stylus 100 through a holder 14 attached on the tool 12.

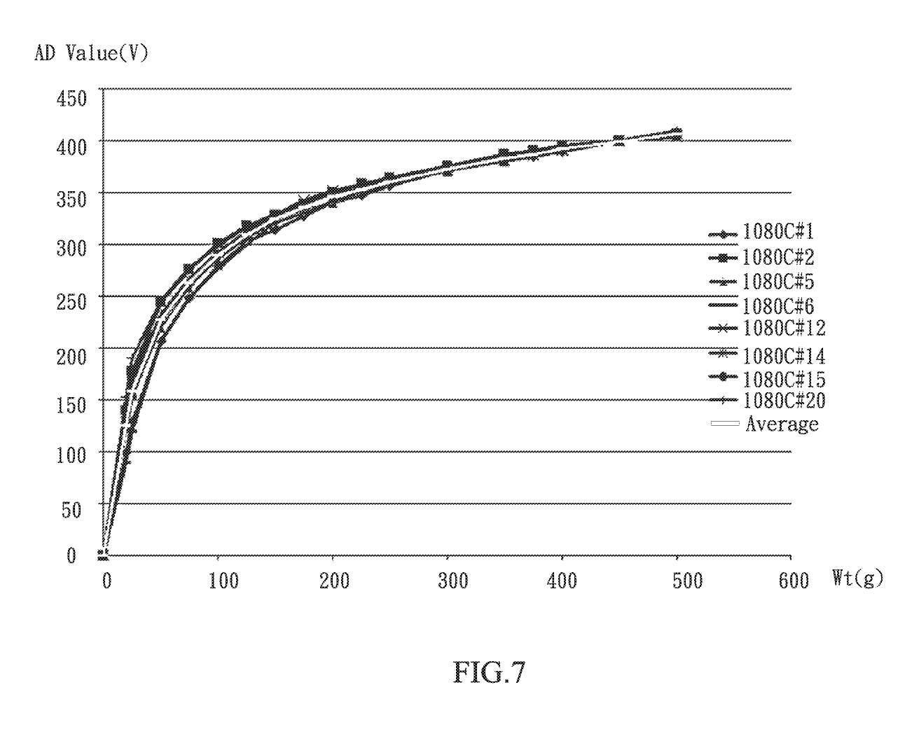

FIG. 7 shows a schematic diagram illustrating mapping of diversified pressure sensing signal curves of styluses after production according to one embodiment of the invention. The styluses are calibrated via mapping pressure sensing signal curves of the styluses with the average pressure sensing signal curve in FIG. 4. The calibrated pressure sensing signal value can be calculated by the following equation.

V_{c}(x)=V(x)−(V(x_{c})−Vₐ(x_{c}))

V_{c} is the calibrated pressure sensing signal value after mapping, x_{c} is the weight of the mapping point applied on the stylus being calibrated. In FIG. 7, for example, x_{c} is 450 g in the embodiment shown in FIGS. 9 and 10. It is noted that a plurality of mapping point can be selected. The weight 16 is preferably a design maximum weight which the stylus can detect, for example, 450 g. The control unit of the stylus 100 generates a pressure sensing signal value V(450 g) corresponding to the weight 16. Then the pressure sensing signal value V(450 g) and an average pressure sensing signal value Vₐ(450 g) corresponding to the weight 16 stored in non-volatile memory of the control unit are used to calculate a calibrated pressure sensing signal value V_{c}. The difference between V(450 g) and Vₐ(450 g) or a calibration reference value is obtained by comparing V(450 g) and Vₐ(450 g). The difference between V(450 g) and Vₐ(450 g) or a calibration reference value is stored in the non-volatile memory of the control unit for calibration of stylus. The calibrated pressure sensing signal value V_{c} can be calculated by the following equation.

V_{c}(x)=V(x)−(V(450 g)−Vₐ(450 g))

The mapping of pressure sensing signal curve of stylus set forth can be performed by a program encoded in the non-volatile memory of the control unit. Thus after production, quality control personnel can use the tool 12, the holder 14 and the weight 16 to calibrate newly produced styluses on the touch panel 10.

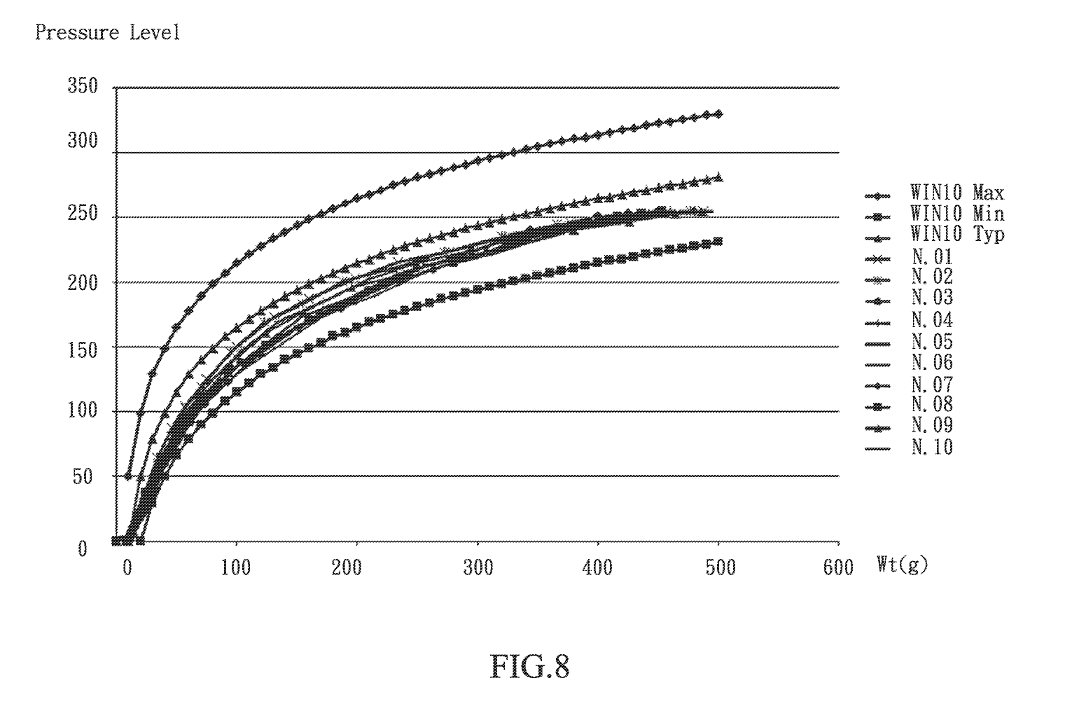

FIG. 8 shows a schematic diagram illustrating mapping of pressure level curves of styluses during usage according to one embodiment of the invention. As shown in FIG. 8, three predetermined standard pressure level curves of Microsoft® Window 10 standard for stylus comprising a maximum pressure level curve, a typical pressure level curve and a minimum pressure level curve are provided. Also in FIG. 8, styluses N1 to N10 with pressure level curves fit within scopes of the standard pressure level curves of Microsoft® Window 10 standard for stylus are shown. During usage, users can also calibrate their styluses via the data of the pressure level mapping curve and the program for mapping of pressure sensing signal curve of stylus encoded in the non-volatile memory of the control unit. For example, when the user applies the stylus against a touch panel, a pressure sensing signal value is generated by the control unit of the stylus. The pressure sensing signal value is then calibrated by the program for mapping of pressure sensing signal curve to generate a calibrated pressure sensing signal value. This calibrated pressure sensing signal value is then converted or calculated to form a pressure level via the data of the standard pressure level mapping curve encoded in the embedded non-volatile memory of the control unit of the stylus. Thus the pressure level curves of the styluses achieve within the scopes of the dedicated standard pressure level curves of Microsoft® Window 10 standard for stylus.

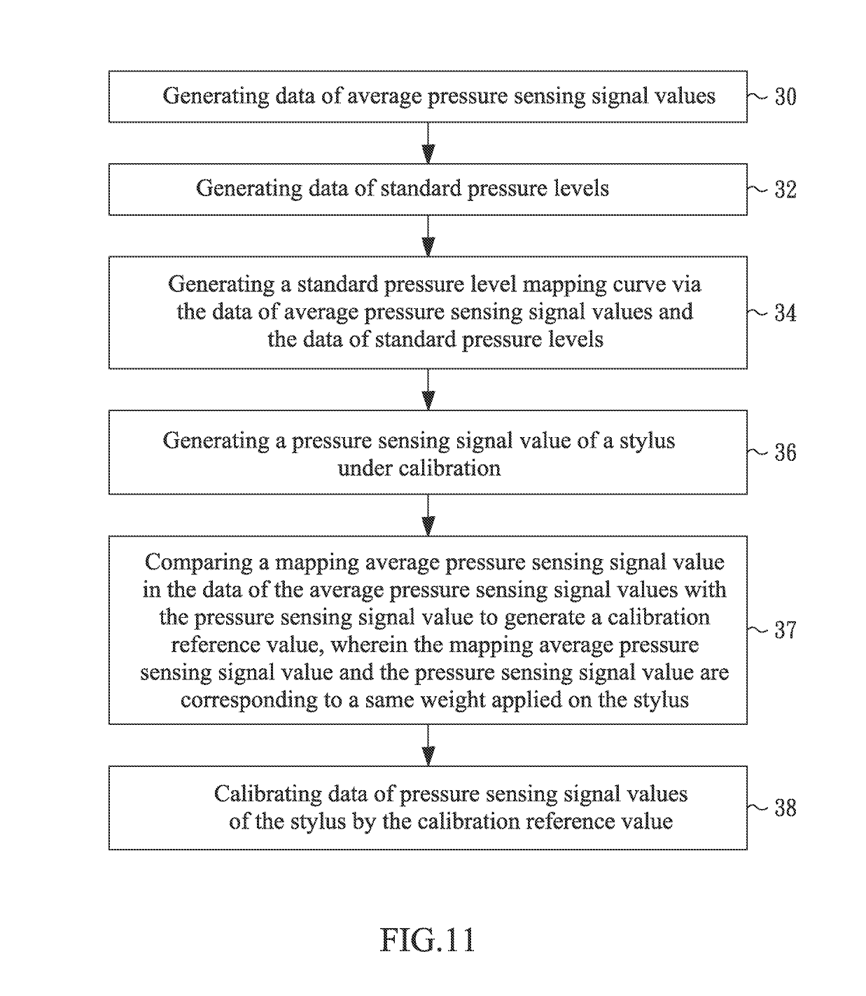

FIG. 11 depicts a method for calibrating stylus pressure mapping curve according to one embodiment of the invention. First of all, in step 30, data of average pressure sensing signals are generated. Then in step 32, data of standard pressure levels are generated. Next in step 34, a standard pressure level mapping curve is generated via the data of average pressure sensing signals and the data of standard pressure levels. Then in step 36, a pressure sensing signal of a stylus under calibration is generated. Next in step 37, a mapping average pressure sensing signal in the data of the average pressure sensing signals is compared with the pressure sensing signal to generate a calibration reference value, wherein the mapping average pressure sensing signal and the pressure sensing signal are corresponding to a same weight applied on the stylus. Finally, in step 38, data of pressure sensing signals of the stylus is calibrated by the calibration reference value.

Although specific embodiments of the present invention have been described, it will be understood by those of skill in the art that there are other embodiments that are equivalent to the described embodiments. Accordingly, it is to be understood that the invention is not to be limited by the specific illustrated embodiments, but only by the scope of the appended claims.

1. A method for calibrating stylus pressure mapping curve, comprising:
generating data of average pressure sensing signal values from pressure sensors of a plurality of capacitive styluses;
generating data of standard pressure levels;
generating a standard pressure level mapping curve via the data of average pressure sensing signal values and the data of standard pressure levels;
generating a pressure sensing signal value from a pressure sensor of a capacitive stylus under calibration;
comparing an average pressure sensing signal value in the data of the average pressure sensing signal values with the pressure sensing signal value to generate a calibration reference value, wherein the average pressure sensing signal value and the pressure sensing signal value are corresponding to a same weight applied on the calibration stylus under calibration; and
calibrating data of pressure sensing signal values of the capacitive stylus under calibration by the calibration reference value.

2. The method according to claim 1, wherein the standard pressure level mapping curve is generated to meet the requirement of a standard pressure level curve of Microsoft® Window 10 standard for stylus.

3. The method according to claim 1, wherein the standard pressure level mapping curve and the calibration reference value are encoded in embedded non-volatile memory of a control unit of the stylus.

4. The method according to claim 1 further comprising a step of generating a pressure level curve by the standard pressure level mapping curve and the calibration reference value.

5. A capacitive stylus under calibration with a pressure mapping function, comprising:
a control unit with embedded non-transitory computer readable medium storing executable instructions for performing a method for calibrating stylus pressure mapping curve, comprising:
generating data of average pressure sensing signal values from pressure sensors of a plurality of capacitive styluses;
generating data of standard pressure levels;
generating a standard pressure level mapping curve via the data of average pressure sensing signal values and the data of standard pressure levels;
generating a pressure sensing signal value from a pressure sensor of the capacitive stylus under calibration;
comparing an average pressure sensing signal value in the data of the average pressure sensing signal values with the pressure sensing signal value to generate a calibration reference value, wherein the average pressure sensing signal value and the pressure sensing signal value are corresponding to a same weight applied on the capacitive stylus under calibration; and
calibrating data of pressure sensing signal values of the capacitive stylus under calibration by the calibration reference value.

6. The stylus according to claim 5, wherein the method for calibrating stylus pressure mapping curve further comprising a step of generating a pressure level curve by the standard pressure level mapping curve and the calibration reference value.
